(19) United States
(12) Patent Application Publication
(10) Pub. No.: US 2004/0062032 A1
(43) Pub. Date: Apr. 1, 2004

(54) Self-illuminated reflective materials for signage and the like

(76) Inventor: Charles A. Mass, Redcliff (CA)

Correspondence Address: RANDALL S. MITCHELL, c/o Ridout & Maybee LLP, Suite 2400, One Queen Street East, Toronto, ON, M5C 3B1, CA

(21) Appl. No.: 10/259,603

(22) Filed: Sep. 30, 2002

(51) Int. Cl. F21V 9/16; G09F 13/16; G09F 13/22

(52) U.S. Cl. 362/84; 362/108; 362/540; 362/812; 40/544; 40/582

(57) ABSTRACT

Safety vests, highway traffic signs and other articles having reflective or fluorescent surfaces for the purpose of enhanced visibility at night when oncoming vehicle are given a substantially higher level of night visibility by the incorporation of candescent light-emitting diodes integrally into the reflective surfaces.

The present invention relates to improved reflective and fluorescent materials for use in safety vests, highway traffic signs and other applications in which clear visibility at night to a driver is essential.

According to the present invention, candescent light-emitting diodes (LEDs) are integrally incorporated into reflective signage or clothing materials of the kind used to render traffic signs, persons, other vehicles, etc. visible at night to an oncoming vehicle. I have found that the clarity and distance at which such warning signs or articles of clothing can be visible at night by road-workers and emergency vehicles is greatly increased through the incorporation of LEDs within the reflective/fluorescent surfaces of the articles to be seen by night drivers.

The LEDs are powered by small conventional batteries such as “C” alkaline batteries which can be conveniently and unobtrusively mounted into the signage or articles of clothing according to the invention.

The drawings and description which follow illustrate the variety of applications to which the invention may be applied, without any intention of limiting the applications contemplated or circumscribing the invention, which is readily adapted for use with a range of existing road safety devices.

The drawings and description which follow illustrate the variety of applications to which the invention may be applied, without any intention of limiting the applications contemplated or circumscribing the invention, which is readily adapted for use with a range of existing road safety devices.

### BRIEF DESCRIPTION OF THE DRAWINGS

FIG. 1A, is a schematic view in vertical cross-section of a light-emitting diode (LED)of a kind useful in the present invention;

FIG. 1B, is a top plan view of the LED of FIG. 1A;

FIG. 2, is an illuminated STOP & SLOW traffic control paddle incorporating reflective materials and LEDs according to the invention;

FIG. 3, is an illuminated WIDE LOAD mat embodying the invention;

FIG. 4, is an illuminated SLOW MOVING VEHICLE (SMV) incorporating reflective materials and LEDs according to the invention;

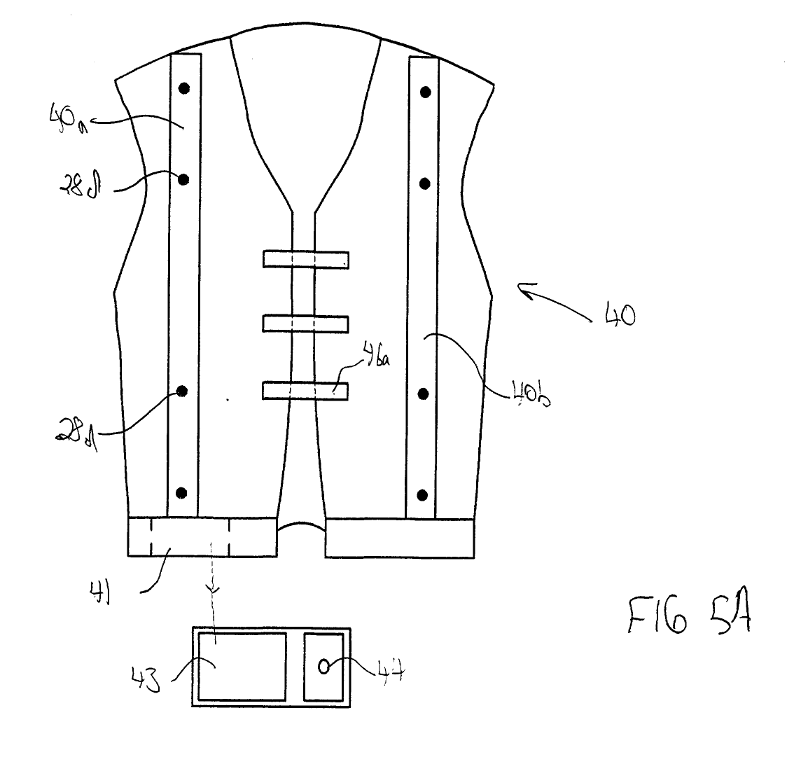

FIG. 5A, is a schematic front view of a safety vest for night visibility, according to an embodiment of the invention;

FIG. 5B, is a rear view of the jacket of FIG. 5A; and

FIG. 6, is a sequentially flashing illuminated chevron according to the invention.

### DESCRIPTION OF PREFERRED EMBODIMENTS

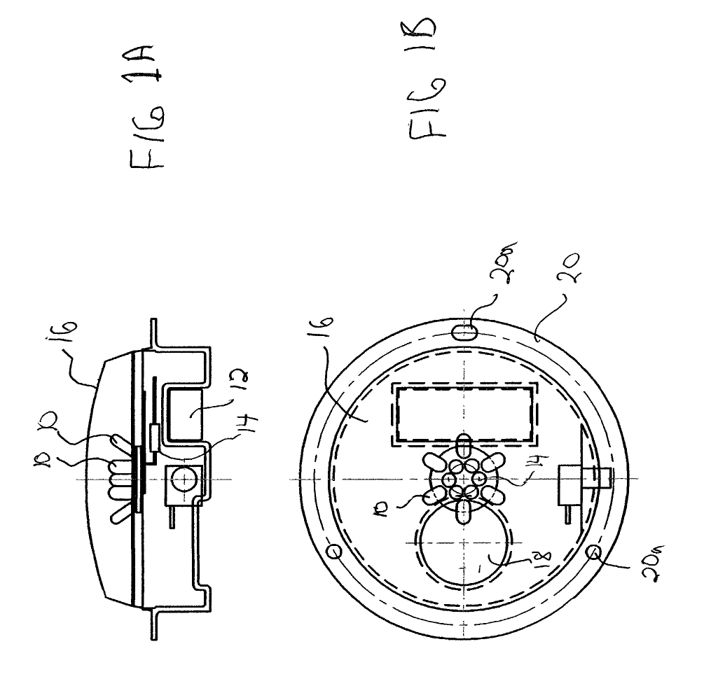

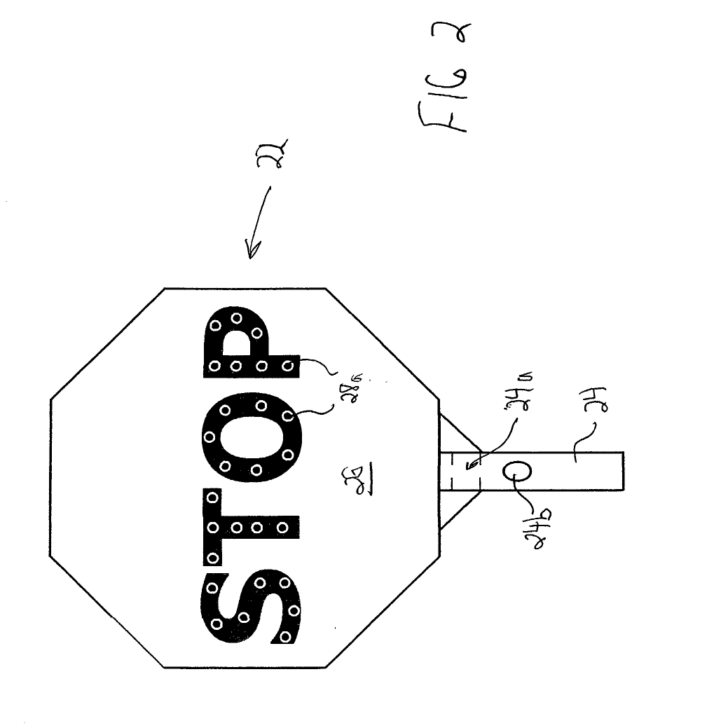

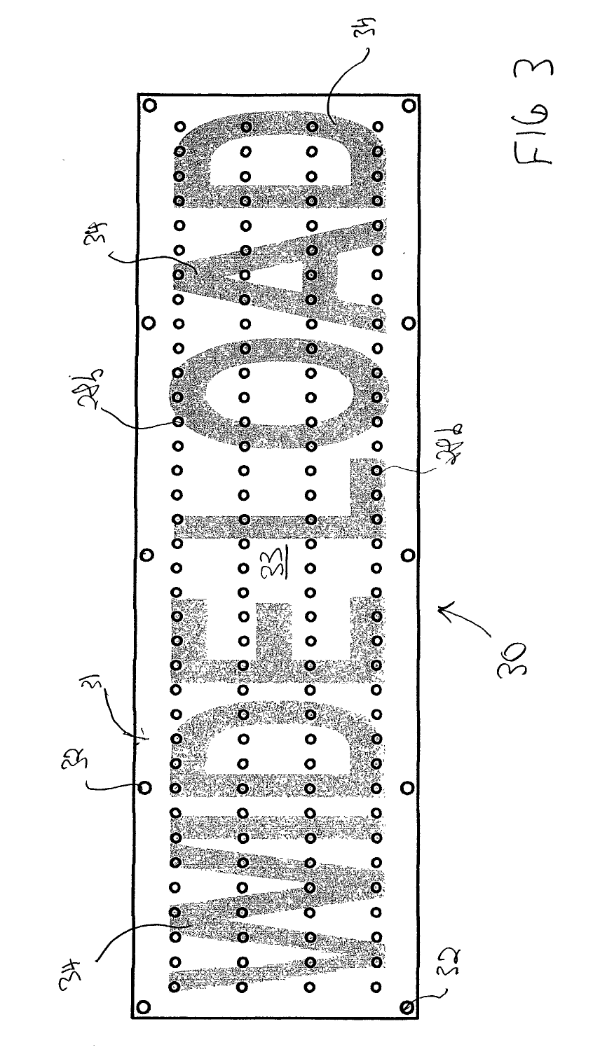

Referring to FIGS. 1 and 2, LEDs used in the present invention are commercially available items including a radially distributed array of bulbs 10 powered by a self-contained battery 12 and a suitable arrangement of resisters 14. The bulbs are covered and protected by a dome shaped transparent lens 16, the off/on switch is illustrated as 18. The LED is backed by reflective material which forms a circumscribing ring 20 including circumferential mounting holes 20a.

It will be understood that the following specifically described embodiments of applications for the combined use of LEDs and reflective materials is illustrative only and not intended to be exhaustive.

(i) Illuminated STOP & SLOW Paddle

The paddle indicated generally at 22 comprises a handle portion 24. The octagonal sign portion comprises front and back fluorescent red PVC plastic panels that read STOP on one side and SLOW on the opposite side [not shown]. Front and back panels 26 will be fixedly spaced apart by about 8 mm to form a hollow interior space for the LED wiring. Batteries for powering the LEDs will typically be in the handle of the paddle at, say, 24a and off/on switch is also mounted for ready access in the handle at 24b.

The octagonal units of 12″, 14″, or 18″ diameter sizes read are fluorescent red octagon with white letters reading STOP on one side, SLOW on the other. There are letters that have red 3000 candescent 3 mm diameter LEDs 28a facing through the front side of the letters. For Example, S-7 LEDs, T-6 LEDs, O-7 LEDs and P-7 LEDs spaced equally in each letter may be used, 27 in total.

The side 26 reading STOP has the handle thermo-moulded large enough to hold two “C” batteries. It is also equipped with a switch, flasher, and sequencer. The opposite side of the unit reads SLOW.

The back side reading SLOW is preferably given a reflective orange (cautionary) colour.

The LEDs 28a are 3000 candescent and 3 mm in diameter. The LEDs are inserted from the rear on the paddle reading SLOW to the front. The letters are PVC black, the same colour as the complete unit. The first click on the switch activates STOP and a double click activates SLOW.

Most importantly, I have found that with a sign of this construction, this invention is that the flashing words STOP and SLOW can be seen from at least 3,000 feet away on a clear night by road-workers and emergency vehicles.

A gasket (not shown) between the front and back halves, with screws, serves to make the unit completely water-resistant. The end of the handle may be threaded to accommodate a longer handle extension to support the unit from the ground. The STOP and SLOW reflective material is Department of Transportation-approved by using 3M™ materials.

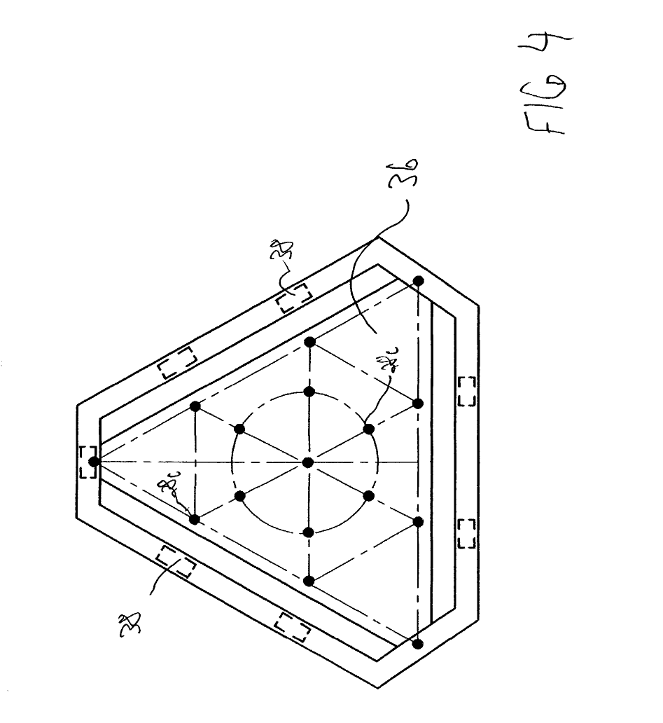

(ii) Illuminated Wide Load Mat—FIG. 3

This mat 30 is 1′ wide by 6′ long with a 1″ border of rubberized vinyl around the border using 3M™ reflective yellow material that is 1′ wide by 6′ long. This is used as the front side of the product. A die is used to cut a 1′ by 6′ foam ⅛″ thick, also punching 144 holes 3 mm in diameter.

The four rows of 35 LEDs 28b of 5000 candescence are 2½″ in from the border and are equally spaced. The circuitry of 144 LEDs is wired in parallel 6′ in length with a voltage of 12 volts. The LED circuitry is installed through holes in the foam with the bulbs facing the front. Using rubberized vinyl as the backing and as the front perimetrical border, the foam is installed in the middle with yellow reflective material across the front central portion 33 containing the LEDs.

Around a 2″ border 31, preferably of black rubberized vinyl, ten grommet holes 32 are installed. The foam is used as a reflector base behind the yellow 3M™ 1′ wide by 6′ long material. The entire 1′ wide by 6′ long surface still has a fully reflective area when the LEDs are unlit. The surface doesn't lose any reflectiveness when the LEDs are turned on and the lighted diodes assist in better reflective qualities.

Black vinyl NO Pre Mask Series “E”, 9″ high letters 34 are installed across the front of the yellow reflective material. The unit is very pliable and durable at sub zero temperatures. The yellow reflective 3M™ material is Department of Transportation-approved. The visibility is about 2,500 feet.

(iii) Illuminated SMV Mat—FIGS. 7 and 8

Using red and orange 3M™ reflective material cut to the standardized size of a “slow-moving vehicle” sign as required by the applicable legislation. A ⅛″ thick foam pad 36 die-punched with sixteen LEDs 28c. These 5 mm amber 5000 candescent LEDs are inserted into the foam, nine of the LEDs forming a triangle and seven as a “bulls-eye” in the middle, the bulbs piercing through the opposite side of this foam with LEDs are installed behind the 3M™ red and orange material using white foam as the reflector base. When lit, the LEDs show through from the front to make the 3M™ product reflective.

The backing is made rubberized vinyl and has magnets and three grommet holes installed around the 1″ perimeter. The magnets are behind the vinyl so the magnets do not scratch the paint on the equipment it is attached to.

To complete the unit, a pouch (not shown) is made on the back side for a battery and a switch with a flasher. The circuitry of this unit is 9 volt. Around the triangle border is 2″ reflective material type 3M™ product. All reflective materials are Department of Transportation-approved. When not illuminated, it still meets all reflective requirements. This arrangement appreciably does not decrease any properties of reflectiveness, but serves to enhance the LED's brightness to be seen from a minimum of 3,000 feet.

The life expectancy is up to a million hours on a diode. The draw is minimal for longevity of the 9-volt battery.

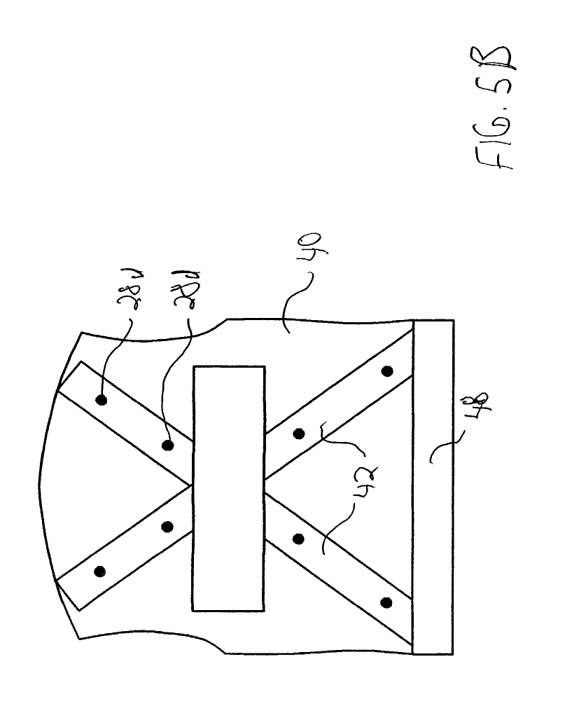

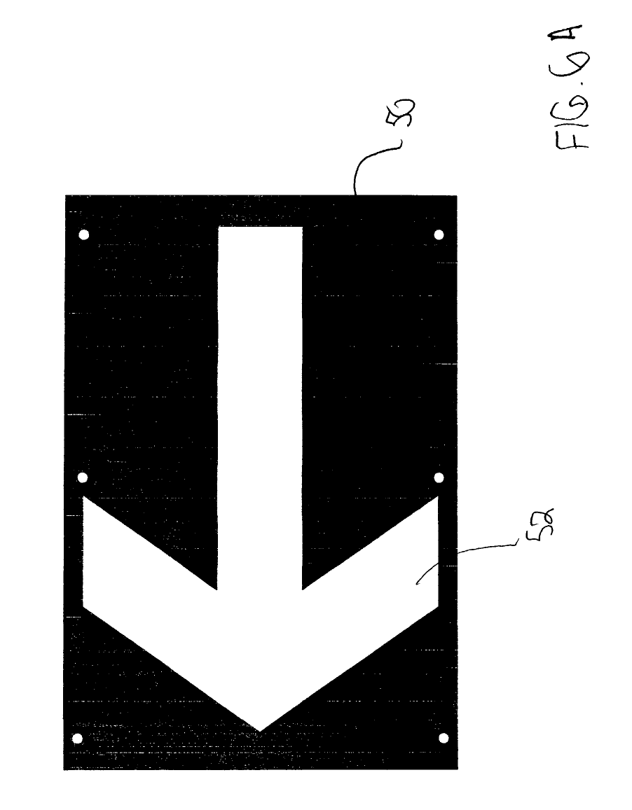

(iv) Illuminated Vest—FIGS. 5A and 5B

The fabric used to sew the vest 40 is a fluorescent orange 7½″ PVC coated mesh. Eight amber or red LEDs 28d, preferably of type 16-3500, are installed in front and rear of the vest, in a parallel pair of 2″ 3M™ reflective strips 40a and 40b heat sealed to the front. A rod is used to put a hole completely through the middle so the circuitry is installed through the 1″ wide foam and pulled through the inside of the yellow reflective material. The wires are installed in the rear hem of the vest when the reflective material is sewn on with two vertical strips on the front and an “X” 41 on the back.

A pocket 42 for battery 43 and switch 44 is installed in foam for a protective cushion against the wearer's body. The unit is totally water-resistant.

Again, the illuminated LEDs within the strips of reflective material still give 100% of area reflectiveness, meeting Worker's Compensation Board approval. There is 2″ full Velcro™ on the front closures 46a and side closures (not shown) with reflective sides using Scotchlite™ reflective material. The illumination of red or amber LEDs 28d can be seen from a minimum of 2,500 feet. Two strips 48 of 3M™ 2″ wide are sewn around the lower part of the vest horizontally 1″ apart, which meets the specifications of ANSI/SEA 107-1999. All reflective materials are Department of Transportation-approved.

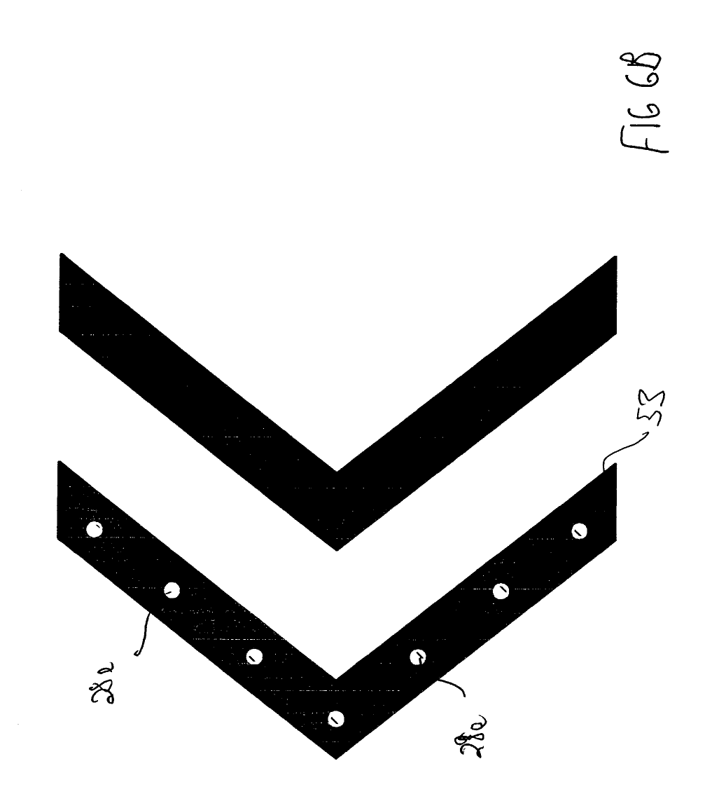

(v) Flashing Arrow Chevron Mats—FIGS. 6A and 6B

Using rubberized vinyl, the complete mat 50 is developed with a pocket 24″ wide—length continuous on rear using Velcro™ to close, depending on the size of the arrow 52 or the number of arrowheads (chevrons). The chevrons 53 are developed by two 8″ pieces of 3M″ 2″ wide yellow reflective material, put at a 90° angle. A rod is pushed through the middle to make a hollow to pull the LED circuitry of seven LEDs 28d—3 mm in diameter—per chevron red or amber—5000 candescence. The LEDs 28d are mounted ⅛″ thick, 1″ wide onto pliable foam for great reflectiveness. These are Department of Transportation-approved.

The power supply is two “C” batteries, 3 volts, with a water-resistant switch with a built-in sequencer to make multiple flashes for each chevron to flash as one, two, three, four, etc. The flash following illumination of the last chevron lights all chevrons. Magnets are installed behind the rubberized material to mount against metal backing. Also, grommet holes are installed in each corner and the middle depending on the length of the arrow mat. To add extra chevrons, the units simply have to be plugged into the circuitry. The visibility is about 3,000 feet at night.

I claim:

1. In an article having reflect and/or fluorescent surfaces for increasing the visibility of said article at night to the driver of the vehicle, the improvement comprising a plurality of light-emitting diodes mounted to at least one of said reflective and/or fluorescent surfaces, and a self-contained power source with electrical circuitry for illuminating the light-emitting diodes, thereby enhancing the visibility of the article.

2. The improvement of claim 1, wherein said article is a highway traffic sign having at least one plainer reflective surface bearing characters or symbols meant to be seen by an approaching driver.

3. The improvement of claim 2, wherein said highway traffic sign comprises front and back flat panels having reflective outer surfaces, fixed in a handle in spaced apart parallel relationship, said electrical circuitry being enclosed between the two panels and said power source being a battery contained within the handle.

4. The improvement of claim 3, wherein said highway traffic sign includes manually actuable on-off means located in the handle of the sign.

5. The improvement of claim 1, wherein said article is a reflective sign fixed to the rear of the vehicle, said sign bearing cautionary lettering or symbols for the attention of the drivers approaching said vehicle from the rear.

6. The improvement of claim 1, wherein said article is an item of clothing having portions of its surface of a reflective material to increase the visibility of the wearer of the article of clothing to traffic at night.

7. The improvement of claim 6, wherein said item of clothing is a sewn fabric safety vest for use by a highway traffic worker and said light-emitting diodes are installed along reflective strips of material fixed to the front and back surfaces of the vest, said electrical circuitry being enclosed between surfaces of the fabric of the vest and said power source being a battery replaceably held in a pocket formed in the vest.
